(19) United States
(12) Patent Application Publication
(10) Pub. No.: US 2025/0182390 A1
(43) Pub. Date: Jun. 5, 2025

(54) Full Body Synthesis for Artificial Reality Environments

(71) Applicant: Meta Platforms Technologies, LLC, Menlo Park, CA (US)

(72) Inventors: Robin KIPS, Zurich (CH); Manoj Kumar Marram REDDY, Zurich (CH); Giancarlo DI BIASE TROCCOLI, Thalwil (CH); Sanjeev KUMAR, Zurich (CH); Carlos CHACON NAVARRO, Munich (DE); Vijaya REDDY, Zurich (CH); Yuhua CHEN, Zurich (CH); Filippo ARCADU, Zurich (CH); Nadine Andrea RUEEGG, Uerikon (CH); Ferran RIGUAL APARICI, Adliswil (CH); Aleksei SIDNEV, Zurich (CH); Artsiom SANAKOYEU, Zurich (CH); Gerard BAHI VILA, Thalwil (CH); Nebojsa ANDELKOVIC, Zurich (CH); Yuting YE, Redmond, CA (US)

(21) Appl. No.: 18/896,138

(22) Filed: Sep. 25, 2024

Related U.S. Application Data
(60) Provisional application No. 63/605,160, filed on Dec. 1, 2023.

(51) Int. Cl. G06T 17/00; G02B 27/01; G06T 7/20; G06T 7/60; G06T 7/70

(52) U.S. Cl. CPC G06T 17/00; G02B 27/017; G06T 7/20; G06T 7/60; G06T 7/70

(57) ABSTRACT

Artificial reality (XR) experiences today typically only provide users representations of their upper body (e.g., as avatars). Although legs do not have a high range of movement or expression in XR, they are required to bring a sense of believability to digital humans represented in XR. However, tracking legs can be difficult because they are frequently not visible to XR device cameras. Aspects of the present disclosure provide a full body synthesis system that can generate plausible full body poses of users by leveraging generative machine learning, in real time, on an XR device. The full body synthesis system can be flexible to multiple numbers and types of inputs (e.g., positions/rotations/accelerations of joints, computer vision models, etc.), and can generalize users of any height, body scale, and body shape.

### CROSS-REFERENCE TO RELATED APPLICATIONS

This application claims priority to U.S. Patent Application No. 63/605,160, filed on Dec. 1, 2023, titled “Full Body Synthesis for Artificial Reality Environments,” which is herein incorporated by reference in its entirety.

### TECHNICAL FIELD

The present disclosure is directed to using machine learning to synthesize a full body representation of a user for use in an artificial reality (XR) environment.

### BACKGROUND

Artificial reality (XR) devices are becoming more prevalent. As they become more popular, the applications implemented on such devices are becoming more sophisticated. Mixed reality (MR) and augmented reality (AR) applications can provide interactive three-dimensional (3D) experiences that combine images of the real-world with virtual objects, while virtual reality (VR) applications can provide an entirely self-contained 3D computer environment. For example, an MR or AR application can be used to superimpose virtual objects over a real scene that is observed by a camera. A real-world user in the scene can then make gestures captured by the camera that can provide interactivity between the real-world user and the virtual objects. AR, MR, and VR (together XR) experiences can be observed by a user through a head-mounted display (HMD), such as glasses or a headset. An HMD can have a pass-through display, which allows light from the real-world to pass through a lens to combine with light from a waveguide that simultaneously emits light from a projector in the HMD, allowing the HMD to present virtual objects intermixed with real objects the user can actually see.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for synthesizing a full body representation of a user for application in an artificial reality environment.

FIG. 6A is a block diagram illustrating an overview of a full body synthesis system for generating a full body pose according to some implementations of the present technology.

FIG. 6B is a block diagram illustrating an overview of a full body synthesis system for generating a full body pose from tracked upper body motion data according to some implementations of the present technology.

FIG. 6C is a block diagram illustrating an overview of a full body synthesis system for generating a full body pose from tracked upper body images according to some implementations of the present technology.

FIG. 6D is a block diagram illustrating an overview of a full body synthesis system for generating a full body pose from tracked visible body images according to some implementations of the present technology.

FIG. 6E is a block diagram illustrating an overview of a full body synthesis system for generating a full body pose from tracked full body motion data according to some implementations of the present technology.

FIG. 7 is a block diagram illustrating a training process for a machine learning model estimating full body pose of a user based on sparse tracking input data according to some implementations of the present technology.

FIG. 8 is a block diagram illustrating an exemplary training pipeline for a machine learning model for estimating full body pose of a user according to some implementations of the present technology.

FIG. 9 is a block diagram illustrating an exemplary prediction pipeline for a machine learning model for estimating full body pose of a user according to some implementations of the present technology.

FIG. 10 is a conceptual diagram illustrating an example kinematic model of a user for an artificial reality device.

The techniques introduced here may be better understood by referring to the following Detailed Description in conjunction with the accompanying drawings, in which like reference numerals indicate identical or functionally similar elements.

### DETAILED DESCRIPTION

Typically, users of artificial reality (XR) experiences only see representations of their upper body (e.g., as avatars). Although legs do not have a comparatively high range of movement or expression in XR, they can be useful to bring a sense of believability to represented digital humans. However, tracking legs can be difficult because they are frequently not visible to XR system cameras. Aspects of the present disclosure provide a full body synthesis system that can generate plausible full body poses of users by leveraging generative machine learning, in real time or near real time, on an XR device. The full body synthesis system can be flexible to multiple numbers and types of inputs (e.g., positions/rotations/accelerations of joints, computer vision models, etc.), and can generalize users of any height, body scale, and body shape.

The processes described herein can employ a two-stage approach, with an initial stage of body sensing and a second stage of full body synthesis. In the first stage, the full body synthesis system can be executed with different modes depending on the available sets of sensors in the XR system (which can include other devices in operable communication with the XR head-mounted display or core processing device), and can return a set of tracked body joints per frame. In the second stage, the full body synthesis system can take, as input, the list of available body sensing signals from the first stage and return a realistic full body pose of the user for each frame. The full body synthesis system can automatically estimate the body scale of the user and account for the body scale in the pose estimation, thereby leading to a truthful representation of the user's body in XR. The full body synthesis system can achieve the second stage using a generative machine learning mode; trained on motion capture data that is generic for any XR device and can be directly adapted to any sensing (i.e., tracking) technology used in the first stage. The full body synthesis system can then use the synthesized full body pose of the user to generate, e.g., a full body representation of the user, such as a hologram or avatar of the user over a single frame (e.g., for a still image) or over multiple frames (e.g., in movement).

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

The implementations described herein provide specific technological improvements in the field of artificial reality. Some implementations can handle diverse types of input (e.g., IMU data, XR system image data, tracked body joint/body part positions using a computer vision model, external device image data, etc.) with different sparsity (e.g., 1 joint, 3 joint, N joints) and return a realistic body pose. Some implementations can handle temporally sparse signals of the user pose and are robust to tracking loss in some joints (e.g., hands, hips, feet, etc.). Further, some implementations can automatically predict the body scale of the user without calibration motion and automatically adapt the predicted pose to the real user scale through scale and space normalization. Thus, some implementations can guarantee a high degree of accuracy across all user heights and body shapes. Some implementations can further run in real-time or near real-time on limited mobile resources (e.g., power, compute, and memory), thereby conserving such resources. Further, by implementing a two-stage model, some implementations can provide a unified approach that is robust to a large variety of XR devices and sensing (i.e., tracking) systems and devices.

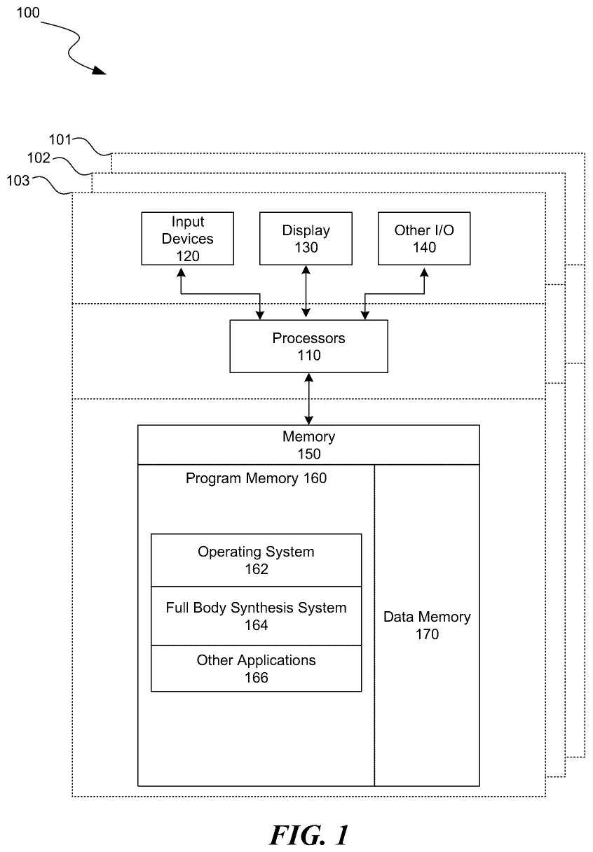

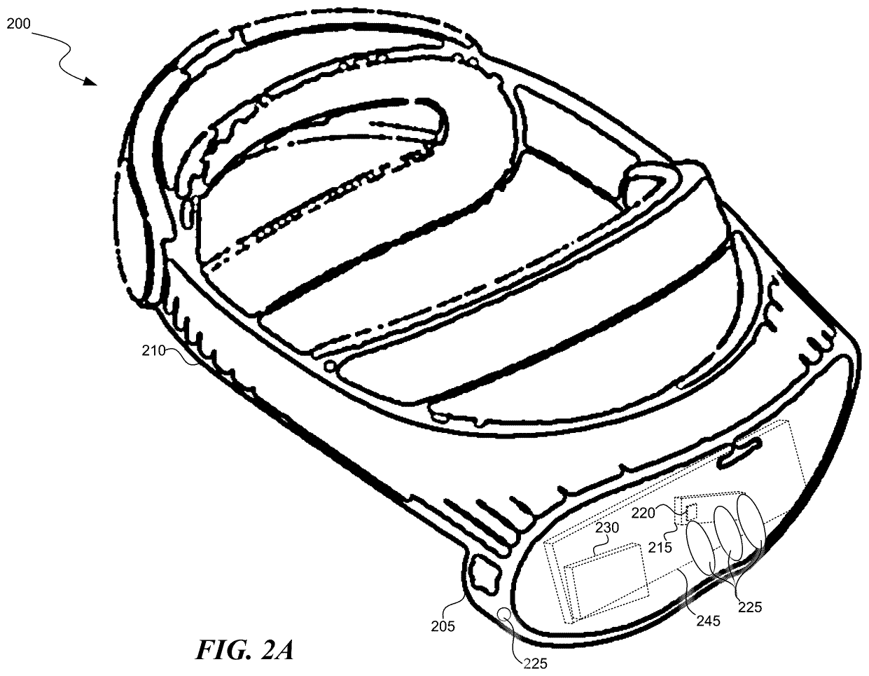

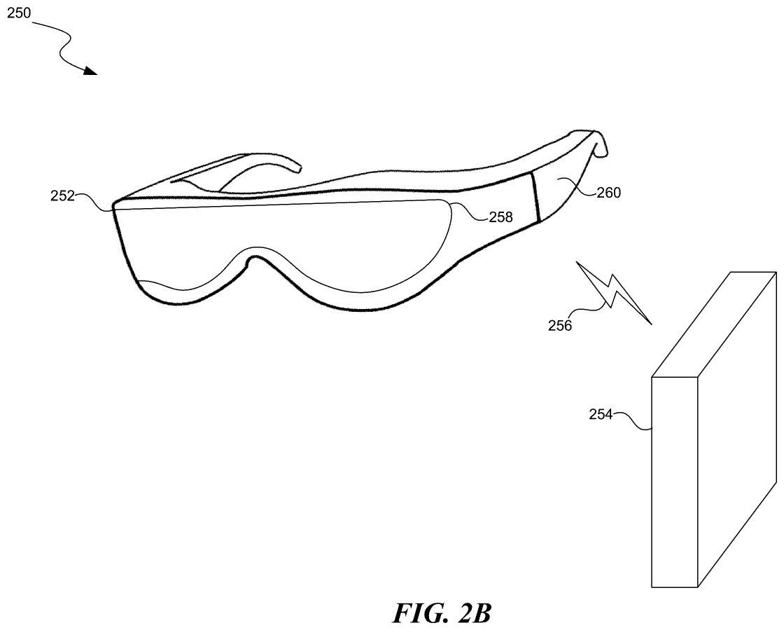

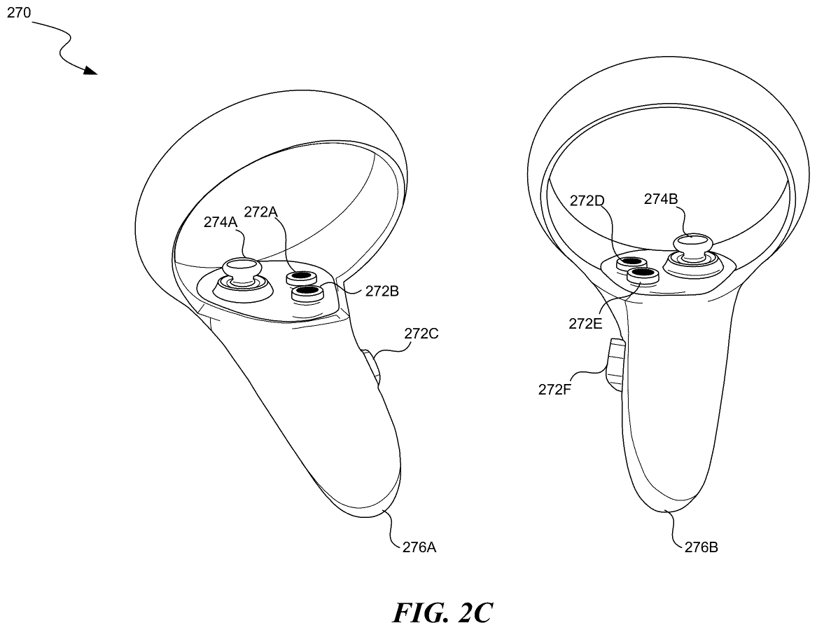

Several implementations are discussed below in more detail in reference to the figures. FIG. 1 is a block diagram illustrating an overview of devices on which some implementations of the disclosed technology can operate. The devices can comprise hardware components of a computing system 100 that can synthesize a full body representation of a user for application in an artificial reality (XR) environment. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, full body synthesis system 164, and other application programs 166. Memory 150 can also include data memory 170 that can include, e.g., body tracking data, body image data, sensor data, motion data, body scale data, machine learning model data, training data, real-world environment data, simulation data, configuration data, settings, user options or preferences, etc., which can be provided to the program memory 160 or any element of the computing system 100.

In various implementations, the technology described herein can include a non-transitory computer-readable storage medium storing instructions, the instructions, when executed by a computing system, cause the computing system to perform steps as shown and described herein. In various implementations, the technology described herein can include a computing system comprising one or more processors and one or more memories storing instructions that, when executed by the one or more processors, cause the computing system to steps as shown and described herein.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

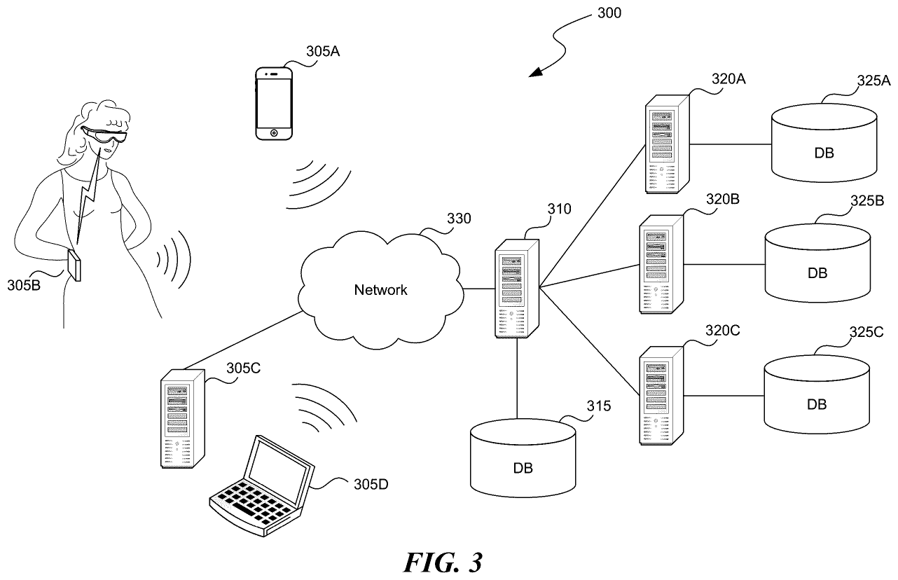

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

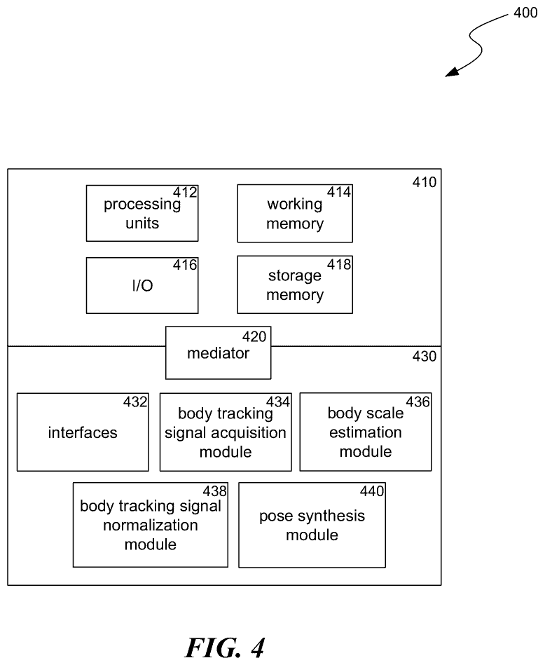

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for synthesizing a full body representation of a user for application in an artificial reality (XR) environment. Specialized components 430 can include body tracking signal acquisition module 434, body scale estimation module 436, body tracking signal normalization module 438, pose synthesis module 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

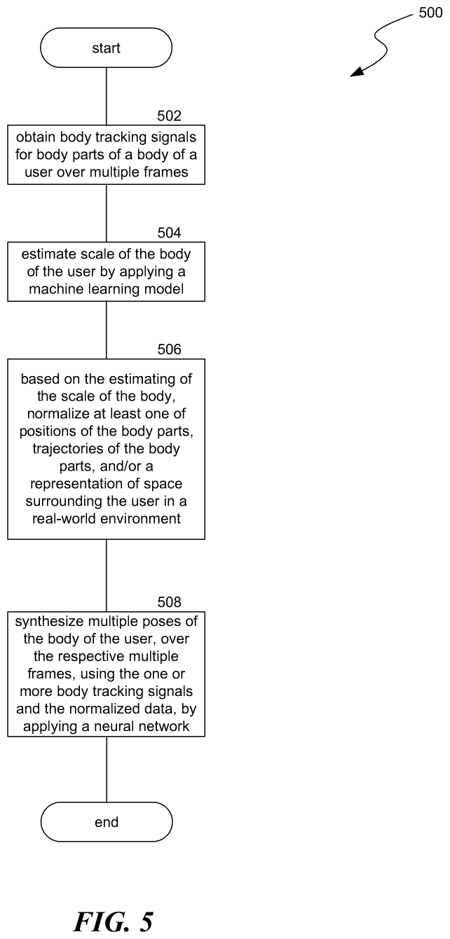

Body tracking signal acquisition module 434 can obtain, over multiple frames, one or more body tracking signals for one or more body parts of a body of a user in a real-world environment. Body tracking signal acquisition module 434 can obtain the body tracking signal(s) from any suitable sensor and/or image capture device, which, in some implementations, can be included in input/output devices 416. For example, in some implementations, body tracking signal acquisition module 434 can obtain the body tracking signal(s) by analyzing images and/or video captured by a camera, by analyzing data collected by one or more sensors of an inertial measurement unit (IMU) of a wearable device worn by the user, by analyzing data collected by one or more electromyography (EMG) sensors of a wearable device worn by the user, by analyzing data collected by an XR system (e.g., XR HMD 200 of FIG. 2A and/or XR HMD 252 of FIG. 2B), by analyzing data collected by one or more controllers (e.g., controllers 276A and/or 276B of FIG. 2C, etc.), and/or the like. In some implementations, each of the body tracking signal(s) can include a position and orientation of a corresponding body part at a particular frame. The multiple frames can be separate points in time at which the body tracking signal(s) are collected, such as when consecutive images of the body are captured. Further details regarding obtaining one or more body tracking signals for one or more body parts, of a body of a user in a real-world environment, are described herein with respect to block 502 of FIG. 5.

Body scale estimation module 436 can estimate scale of the body of the user by applying a first machine learning model to the one or more body tracking signals obtained by body tracking signal acquisition module 434. In some implementations, the scale of the body can include the height of the user and/or one or more bone lengths of the user. In some implementations, body scale estimation module 436 can estimate the height of the user based on the one or more bone lengths of the user. In some implementations, the first machine learning model can be trained on historical body tracking signals collected from users having known heights and/or known bone length(s). Further details regarding estimating scale of a body of a user by applying a first machine learning model to one or more body tracking signals are described further herein with respect to block 504 of FIG. 5.

Body tracking signal normalization module 438 can, based on the scale of the body of the user estimated by body scale estimation module 436, normalize the one or more body tracking signals obtained by body tracking signal acquisition module 434 by one or more processes. In some implementations, body tracking signal normalization module 438 can normalize position(s) of corresponding body part(s), estimated from the body tracking signal(s), to be independent of the estimated scale. In some implementations, body tracking signal normalization module 438 can normalize one or more trajectories of the body part(s), estimated from the body tracking signal(s), based on the estimated scale. In some implementations, body tracking signal can normalize a representation of space, surrounding the user in the real-world environment, based on the estimated scale. In other words, body tracking signal normalization module 438 can adjust the values of the body tracking signal(s), which are measured relative to the specific scale of the body of the user, to a common scale. Further details regarding normalizing one or more body tracking signals based on a scale of a body of a user are described herein with respect to block 506 of FIG. 5.

Pose synthesis module 440 can synthesize multiple poses of the body of the user, over the respective multiple frames, using the one or more body tracking signals normalized by body tracking signal normalization module 438. Pose synthesis module 440 can synthesize the multiple poses by applying a second machine learning model trained on historical motion data, of other bodies of other users, captured by multiple input sensors. In some implementations, the second machine learning model can be a neural network. In some implementations, the second machine learning model can further be trained on one or more masking techniques applied to the historical motion data. The masking technique(s) can account for lack of visibility of the other body parts, of the other users, by the input sensors (e.g., a body part that is not wearing an input sensor, such as an accelerometer, or that is not visible by a camera). Further details regarding synthesizing one or more poses, of a body of a user, using one or more normalized body tracking signals are described herein with respect to block 508 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for synthesizing a full-body representation of a user for application in an artificial reality (XR) environment. In some implementations, process 500 can be performed as a response to a user, application-level, or system-level request to synthesize the full body representation of the user for real time or near real time application in the XR environment. In some implementations, process 500 can be performed as a response to a user, application-level, or system-level request to synthesize the full body representation of the user for later application in the XR environment, such as to generate a playback of the user's simulated motion in the XR environment relative to a previously generated full body representation.

In some implementations, some or all of process 500 can be performed by an XR device, such as an XR head-mounted display (HMD), e.g., XR HMD 200 of FIG. 2A and/or XR HMD 252 of FIG. 2B. In some implementations, some or all of process 500 can be performed by another XR device, external to an XR HMD, within an XR system, such as one or more processing components. In some implementations, some or all of process 500 can be performed by a remote computing system, e.g., a platform or developer computing system (e.g., a server) located remotely from the XR device. In some implementations, process 500 can be performed by full body synthesis system 164 of FIG. 1.

At block 502, process 500 can obtain one or more body tracking signals for one or more body parts, of a body of a user in a real-world environment, over multiple frames. The one or more body parts can include, for example, the user's head, back, hand(s), wrist(s), shoulder(s), arm(s), knee(s), leg(s), back, hip(s), one or more feet, etc. In some implementations, the one or more body parts can include one or more body joints. In some implementations, the number of tracked body parts can vary over the multiple frames. In some implementations, the number of tracked body parts can vary over multiple performances of process 500.

In some implementations, the frames can be predefined consecutive points in time in which body measurements are captured for at least one of the one or more body parts, e.g., at a predefined interval, such as every 100 milliseconds. The one or more body tracking signals can be sets of consecutive data captured at such successive points in time. In some implementations, the predefined intervals can vary between individual body tracking signals, e.g., inertial measurement unit (IMU) data can be continuously monitored, while image data can be captured every 0.5 seconds.

The one or more body tracking signals can include any data indicative of the position, orientation, rotation, motion, pose, gesture, and/or trajectory of the one or more body parts of the body of the user, as captured by one or more sensors and/or tracking devices. In some implementations, at least one of the one or more body tracking signals can be captured by one or more sensors of an inertial measurement unit (IMU), such as one or more gyroscopes, one or more accelerometers, one or more magnetometers, etc. In some implementations, at least one of the one or more body tracking signals can be captured by a compass. In some implementations, at least one of the one or more body tracking signals can be captured by an electromyography (EMG) sensor. In some implementations, at least one of the one or more body tracking signals can be captured by an image capture device (e.g., a visible light, infrared, and/or ultraviolet camera). In some implementations, at least one of the one or more body tracking signals can be captured by a depth sensor. In some implementations, at least one of the one or more body tracking signals can be captured by a light-emitting diode (LED)-based tracker.

In some implementations, the one or more sensors and/or tracking devices can be included in an XR HMD, e.g., one or more IMUs, one or more cameras, and/or one or more depth sensors. In some implementations, the one or more sensors and/or tracking devices can be included in one or more controllers (e.g., controller 276A and/or controller 276C of FIG. 2C), e.g., one or more IMUs. In some implementations, one or more images can be captured by an image capture device external to an XR device and facing the user of the XR device. In some implementations, the one or more sensors and/or tracking devices can be included in a wearable device, such as a smart wristband, smart ankle band, etc. In some implementations, process 500 can generate the body tracking signals from images by applying object recognition, computer vision and/or machine learning techniques.

In some implementations, the one or more body tracking signals can include a confidence value for obtained position and/or orientation data for particular body parts. The confidence value can be any textual, numerical, and/or graphical indicator, such as a percentage. In some implementations, the confidence value can be calculated based on visibility of the particular body parts in one or more captured images. For example, if a body part is fully visible in a series of captured images, or if the body part is at least partially visible in the series of captured images and combined with IMU data, process 500 can calculate a high confidence value, e.g., 80% or higher. If the body part is only partially visible in the series of captured images (without additional IMU data), or if the body part is not visible in particular captured images of the series, process 500 can calculate a lower confidence value (e.g., 70% or lower). In some implementations, process 500 can calculate a confidence value for each frame of captured data per body part, while in other implementations, process 500 can calculate an overall confidence value for the body part over the multiple frames or a subset of the multiple frames.

Process 500 can, based one the one or more body tracking signals, synthesize a full body representation of the user by performing blocks 504-508. At block 504, process 500 can estimate the scale of the body of the user by applying a machine learning model to the one or more body tracking signals. In some implementations, the scale can include the estimated height of the user and/or one or more estimated bone lengths (or body part lengths) of the user's body. In some implementations, the machine learning model can be trained on known, historical body tracking signals associated with users of known scale (e.g., known heights and/or one or more known bone lengths). By estimating the scale of the body of the user, process 500 can reduce ambiguity of the user pose in a context of limited body tracking signals. Further, process 500 can be effectively performed for diverse body scales.

At block 506, process 500 can perform one or more normalization steps using the estimated scale of the body of the user. In some implementations, process 500 can normalize one or more positions of the one or more corresponding body parts, estimated from the one or more body tracking signals, to be independent of the estimated scale. In some implementations, process 500 can normalize one or more trajectories of the one or more body parts, estimated from the one or more body tracking signals, based on the estimated scale. In some implementations, process 500 can normalize a representation of space surrounding the user in the real-world environment, such that process 500 is robust to where the user stands in global space.

At block 508, process 500 can synthesize multiple poses of the body of the user, over the respective multiple frames, using the one or more body tracking signals and the output of the one or more normalization steps. In some implementations, process 500 can synthesize the multiple poses of the body of the user by applying a neural network (or other machine learning model). In some implementations, the machine learning model can be trained on historical motion data, of bodies of other users, captured by multiple input sensors. In some implementations, the multiple input sensors can include different types of input sensors. In some implementations, the machine learning model can further be trained on one or more masking techniques applied to the historical motion data that account for lack of visibility (and/or lack of other tracking data) of one or more other body parts, of the other bodies of the other users, by the multiple input sources. In some implementations, the masking can be fixed or dynamically changed based on motion. In some implementations, the machine learning model can include one or more of several modules, such as a temporal convolutional encoder, a long short-term memory network, a multi-task multi-layer perception model, or any combination thereof. The machine learning model can apply one or more or any combination of multiple losses: body pose reconstruction loss; anatomical representation loss; feet sliding loss; bone length loss; and/or contact classification loss for feet, hips, and/or any other body joints.

Process 500 can return one or more of multiple outputs at block 508. In some implementations, process 500 can return the full body representation of the user (referred to interchangeably herein as a “full body pose”) over the multiple frames. In some implementations, process 500 can return an estimate of global position and rotation of the body of the user. In some implementations, process 500 can return one or more bone lengths of the user. In some implementations, process 500 can return the body pose of the user following an anatomical body representation (e.g., a kinematic model). In some implementations, process 500 can return the probability that one or more foot joints are in contact with the ground, as described further herein. In some implementations, process 500 can return the probability that the user's hips are in contact with a seat or the ground, as described further herein. In some implementations, process 500 can use one or more of these outputs in rendering a full body avatar on the XR device (or on one or more other XR devices of other users viewing the user's avatar in the XR environment. In some implementations, process 500 can expose one or more of these outputs to developer computing systems and/or XR applications on the XR device for application and use.

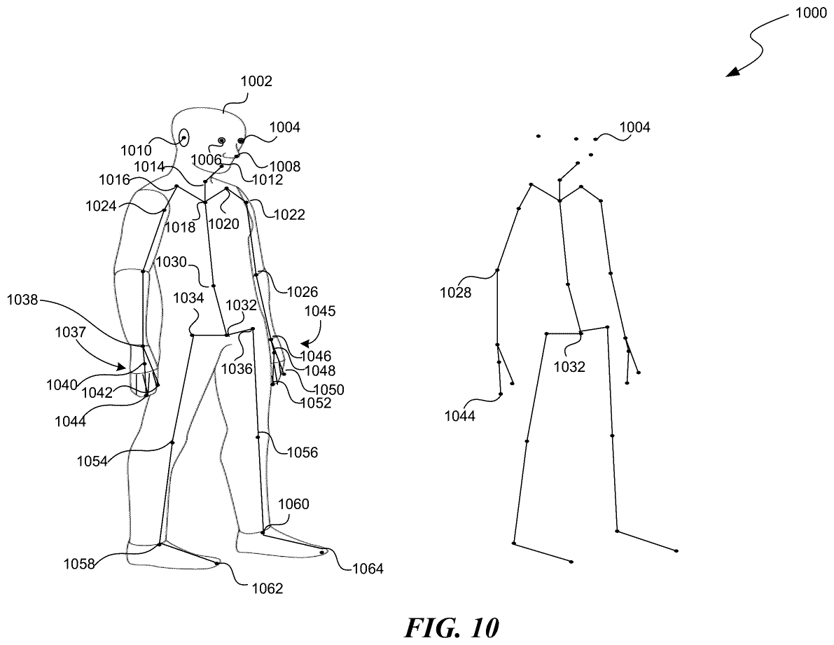

In some implementations, process 500 can synthesize the full body representation of the user as a skeletal and/or kinematic model. In some implementations, the model can define, according to anatomical capabilities and constraints, body configurations of the user per frame, including one or more lower body postures of the user. An exemplary kinematic model of a user for an XR device is shown and described herein with respect to FIG. 10.

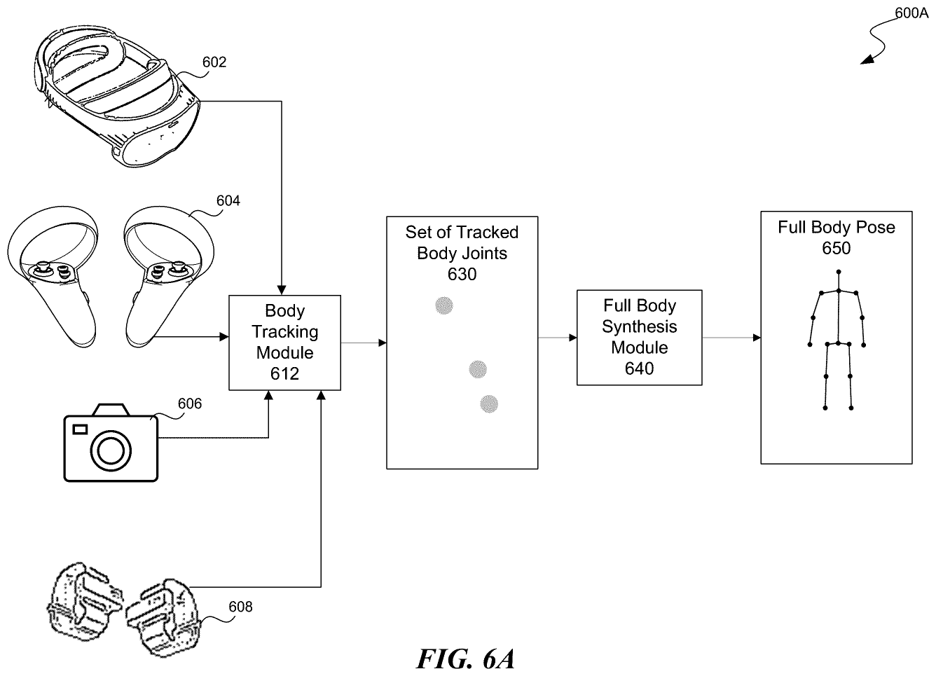

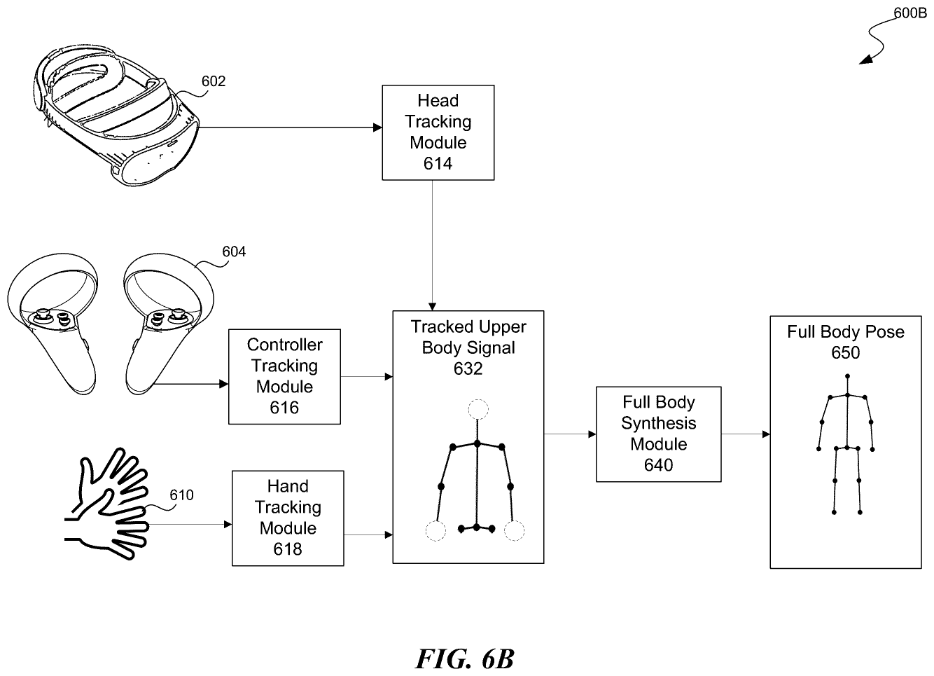

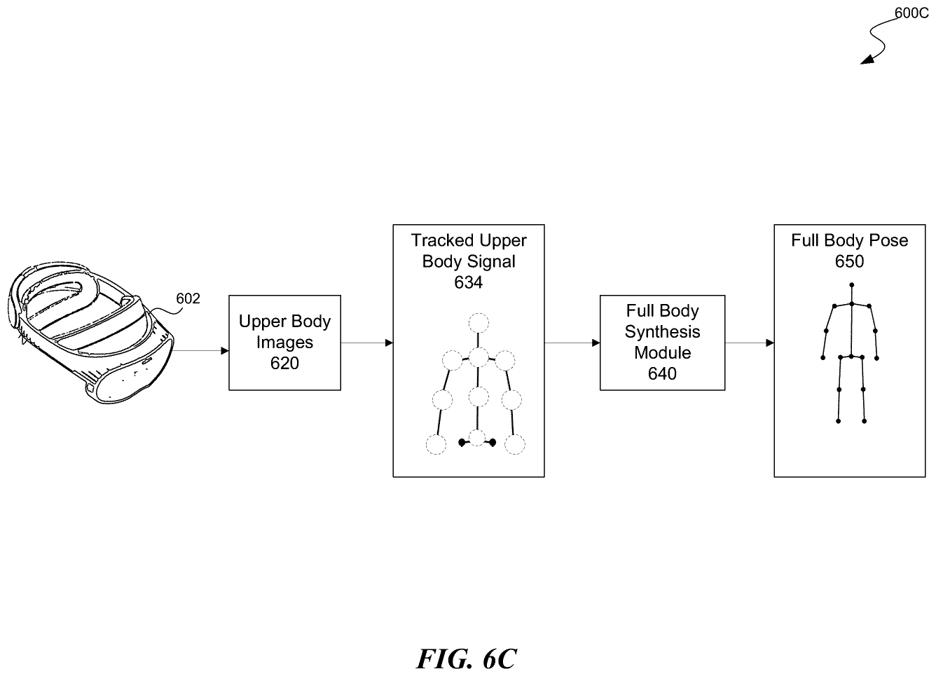

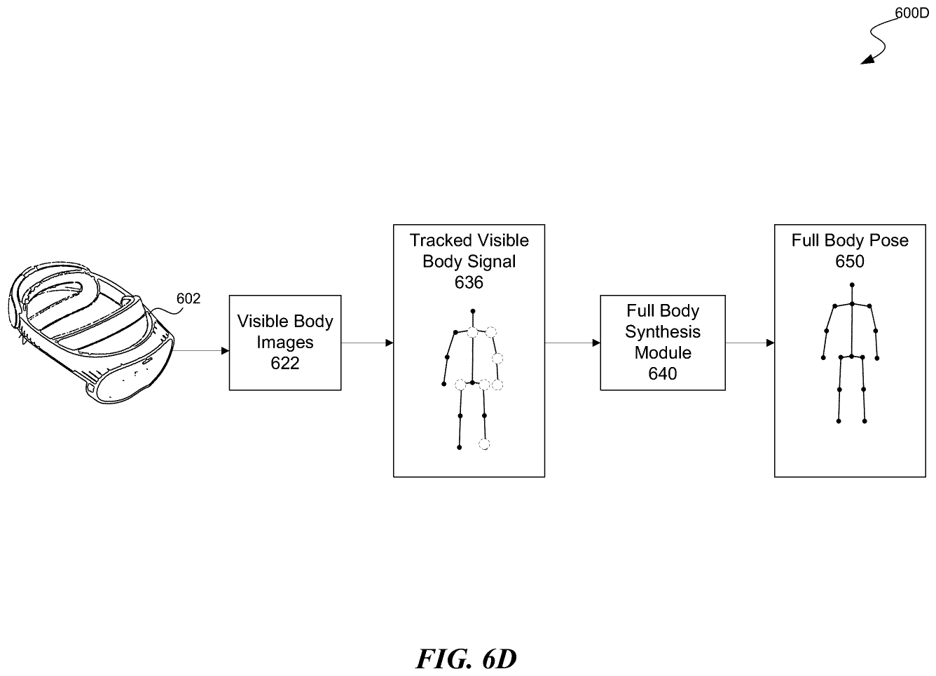

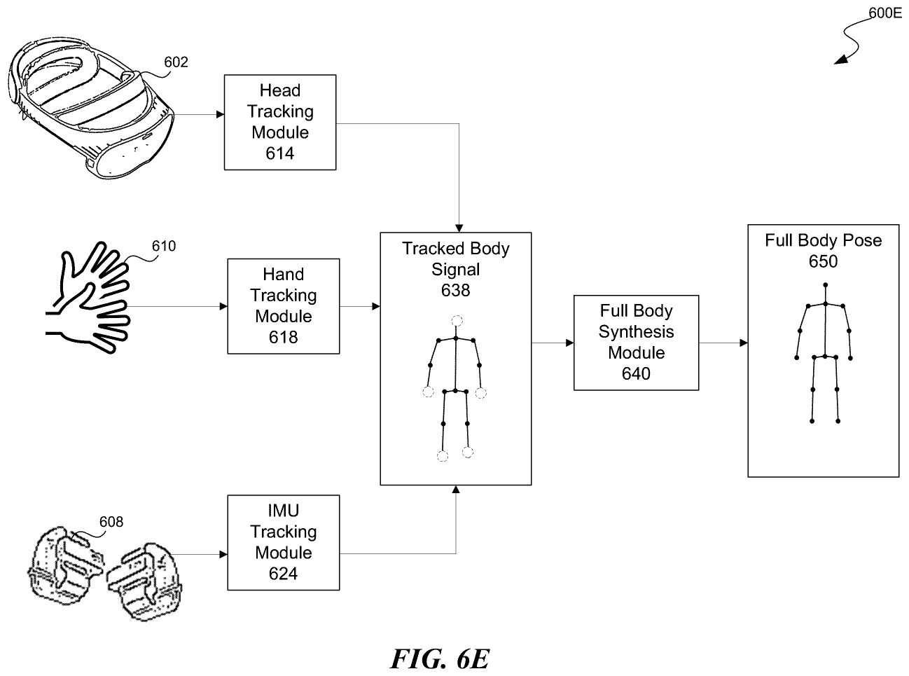

FIG. 6A is a block diagram illustrating an example 600A overview of inputs to and outputs from a full body synthesis system for generating a full body pose 650 according to some implementations of the present technology. Body tracking module 612 of the full body synthesis system can receive one or more body tracking signals (e.g., indicative of position, orientation, rotation, movement, trajectory, etc., of one or more body parts and/or body joints) from one or more of: A) XR HMD 602, B) one or more XR controllers 604, C) one or more external image capture devices 606, D) one or more wearable devices 608, or E) any combination thereof. The full body synthesis system can include body tracking module 612 and full body synthesis module 640.

In some implementations, XR HMD 602 can be similar to XR HMD 200 of FIG. 2A and/or XR HMD 252 of FIG. 2B, as described further herein. In some implementations, XR HMD 602 can capture one or more body tracking signals from one or more integral sensors and/or devices. For example, in some implementations, XR HMD 602 can include one or more sensors of an IMU, such as one or more accelerometers, one or more gyroscopes, one or more magnetometers, etc., for tracking position, orientation, rotation, and/or movement of the head of the user wearing XR HMD 602. In some implementations, XR HMD 602 can include one or more additional or alternative sensors not typically included in an IMU, such as a compass. In some implementations, XR HMD 602 can include one or more image capture devices, such as one or more cameras. The one or more cameras can include one or more inward facing cameras (e.g., pointed toward the face of the user) and/or one or more outward facing cameras (e.g., pointed away from the face of the user), the latter providing “inside out” images of the user. In some implementations, XR HMD 602 (or another device in an XR system in operable communication with XR HMD 602) can perform object recognition and/or detection to identify and/or track one or more body parts within one or more image(s) captured by the camera(s). In some implementations, XR HMD 602 can include one or more depth sensors configured to sense the distance between XR HMD 602 and objects in the real-world environment, such as detected body parts of the user.

In some implementations, controllers 604 can be similar to controllers 276A and/or 276B of FIG. 2C, as described further herein. In some implementations, controllers 604 can capture one or more body tracking signals from one or more integral sensors and/or devices. For example, in some implementations, controllers 604 can include one or more sensors of an IMU, such as one or more accelerometers, one or more gyroscopes, one or more magnetometers, etc., for tracking position, orientation, rotation, and/or movement of one or both hands of the user holding controllers 604. In some implementations, controllers 604 can include one or more additional or alternative sensors not typically included in an IMU, such as a compass.

Image capture device 606 can be external to XR HMD 602 and can provide “outside in” images of the user. For example, image capture device 606 can be positioned in a real-world environment surrounding the user pointed toward the body of the user. In some implementations, image capture device 606 can provide captured image(s) to XR HMD 602 (or another device in an XR system in operable communication with XR HMD 602), which can perform object recognition and/or detection to identify and/or track one or more body parts within one or more image(s) captured by the image capture device 606. In some implementations, image capture device 606 can include one or more depth sensors configured to sense the distance between image capture device 606 and objects in the real-world environment, such as detected body parts of the user.

Wearable devices 608 can include any smart devices configured to be worn on the body of the user to capture body tracking signals for particular body parts, such as a smart wristband, a smart ankle band, etc. Wearable devices 608 can capture one or more body tracking signals from one or more integral sensors and/or devices. For example, in some implementations, wearable devices 608 can include one or more sensors of an IMU, such as one or more accelerometers, one or more gyroscopes, one or more magnetometers, etc., for tracking position, orientation, rotation, and/or movement of the body parts for which wearable devices 608 are worn. In some implementations, wearable devices 608 can include one or more additional or alternative sensors not typically included in an IMU, such as a compass, one or more electromyography (EMG) sensors, etc.

XR HMD 602, controllers 604, image capture device 606, and/or wearable devices 608 can provide raw input data captured by their respective sensors and/or devices to body tracking module 612 which, in some implementations, can perform aggregation, analysis and/or processing for generating set of tracked body joints 630. In some implementations, body tracking module 612 can generate data regarding whether data points within set of tracked body joints 630 (and, in some implementations, data points per frame) are usable. In some implementations, set of tracked body joints 630 can be fast and sparse or slow and coarse. For example, tracking data can be very sparse when tracking one body part (e.g., head), or very coarse when tracking a large number of body parts (e.g., 159).

Body tracking module 612 can provide set of tracked body joints 630 to full body synthesis module 640, which can return a plausible full body pose 650 per frame given the sequence of tracked body joints in set of tracked body joints 630, such as by the process described with respect to blocks 504-508 of FIG. 5. In generating full body pose 650, full body synthesis module 640 can estimate the position of the full body skeleton given any sparsity level of set of tracked body joints 630. In some implementations, full body synthesis module 640 can ensure temporal consistency of the motion of full body pose 650 in case of tracking loss.

Although body tracking module 612 and full body synthesis module 640 are illustrated as being separate from XR HMD 602, it is contemplated that, in some implementations, XR HMD 602 can include and/or perform the functions of body tracking module 612 and/or full body synthesis module 640. In such implementations, it is contemplated that one or more of B) one or more XR controllers 604, C) one or more external image capture device 606, D) one or more wearable devices 608, or E) any combination thereof, which are providing inputs to body tracking module 612, which can be included in XR HMD 602. Alternatively, it is contemplated that body tracking module 612 and/or full body synthesis module 640 can be included in another XR device in an XR system, such as one or more processing components. In some implementations, it is contemplated that body tracking module 612 and/or full body synthesis module 640 can be included in a remote computing system (e.g., a server).

FIG. 6B is a block diagram illustrating an example 600B overview of a full body synthesis system for generating a full body pose 650 from tracked upper body motion data according to some implementations of the present technology. XR HMD 602 can provide raw head motion tracking data to head tracking module 614 of the full body synthesis system. In some implementations, controllers 604 can provide raw controller tracking data to controller tracking module 616. In some implementations, however, XR HMD 602 can track motion of hands 610 via captured images of the hands and provide such hand tracking data to hand tracking module 618, and/or one or more wearable devices worn on hands 610 (or the wrists) can capture hand and/or wrist motion data and provide such hand tracking data to hand tracking module 618. Head tracking module 614, controller tracking module 616, and/or hand tracking module 618 can analyze and process such data to generating tracked upper body signal 632; in this example, a set of data corresponding to motion of the head and hands of the user per frame (i.e., at 3 body points). Tracked upper body signal 632 can be input to full body synthesis module 640, which can generate full body pose 650, including the tracked upper body and an untracked plausible lower body predicted using tracked upper body signal 632.

FIG. 6C is a block diagram illustrating an example 600C overview of a full body synthesis system for generating a full body pose from tracked upper body images according to some implementations of the present technology. XR HMD 602 can capture “inside out” upper body images 620 of the user and/or images indicative of the position, orientation, and/or movement of the upper body of the user. XR HMD 602 (or external processing components or a remote computing system) can perform object recognition and/or detection on upper body images 620 to recognize captured body parts and track their movement to generate tracked upper body signal 634. Upper body signals 634 can include movement data for body parts in the upper body (e.g., head, neck, shoulders, elbows, hands, back, hips, or any combination thereof) per frame for multiple body points. Tracked upper body signal 634 can be provided to full body synthesis module 640, which can generate full body pose 650, including the tracked upper body and an untracked plausible lower body predicted using tracked upper body signal 634.

FIG. 6D is a block diagram illustrating an example 600D overview of a full body synthesis system for generating a full body pose 650 from tracked visible body images according to some implementations of the present technology. XR HMD 602 can capture “inside out” visible body images 622 of portions of the full body of the user (e.g., upper body and lower body), and/or images indicative of the position, orientation, and/or movement of portions of the full body of the user. XR HMD 602 (or external processing components or a remote computing system) can perform object recognition and/or detection on visible body images 622 to recognize visible body parts and track their movement to generate tracked visible body signal 636, which can include movement data for body parts in the upper and lower body (e.g., neck, shoulder, elbow, hand, hips, foot, etc.) per frame for multiple body points. Tracked visible body signal 636 can be provided to full body synthesis module 640, which can generate full body pose 650, including the tracked visible body (including portions of both the upper and lower body) and a partially untracked plausible lower body predicted using tracked visible body signal 636.

FIG. 6E is a block diagram illustrating an example 600E overview of a full body synthesis system for generating a full body pose 650 from tracked full body motion data according to some implementations of the present technology. XR HMD 602 can provide raw head motion tracking data to head tracking module 614 of the full body synthesis system. In some implementations, XR HMD 602 can track motion of hands 610 via captured images of the hands and provide such hand tracking data to hand tracking module 618, and/or one or more wearable devices worn on hands 610 (or the wrists) can capture hand and/or wrists motion data and provide such hand tracking data to hand tracking module 618. In some implementations, wearable devices 608 can be worn on the ankles, and provide ankle tracking data to IMU tracking module 624. Head tracking module 614, hand tracking module 618, and/or IMU tracking module 624 can analyze and process such data to generating tracked body signal 638; here, a set of data corresponding to motion of the head, hands, and ankles of the user per frame (i.e., at 5 body points). Tracked body signal 638 can be input to full body synthesis module 640, which can generate full body pose 650, including the tracked upper body and a partially untracked plausible lower body predicted using tracked body signal 638. In some implementations, full body pose 650 of FIG. 6E can be more accurate than those described relative to FIGS. 6B-6D, as it is based at least partially on known lower body data.

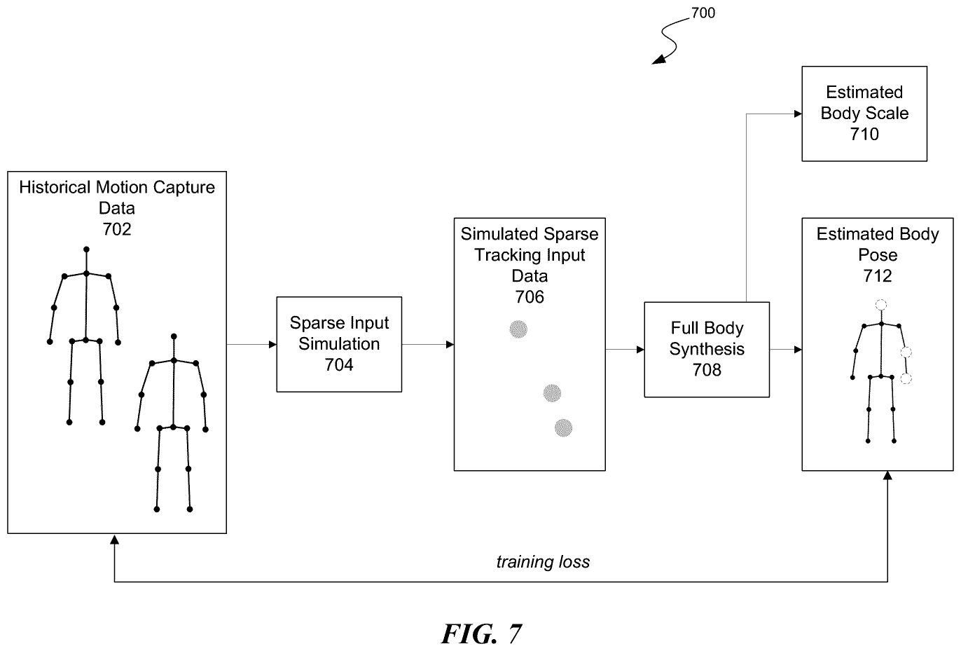

FIG. 7 is a block diagram illustrating a training process 700 for a machine learning model estimating full body pose of a user based on sparse tracking input according to some implementations of the present technology. Process 700 can obtain historical motion capture data 702, which can be a training set of data for the machine learning model, from a database. Historical motion capture data 702 can include known position, orientation, rotation, motion, etc. data for multiple identified body parts of users. In some implementations, historical motion capture data 702 can include images and/or sensor data indicative of the position, orientation, rotation, motion, etc. for the multiple identified body parts of users. In some implementations, historical motion capture data 702 can further include the known scale of the users (e.g., height, bone lengths, body measurements, etc.).

Process 700 can perform sparse input simulation 704 on historical motion capture data 702 or a subset thereof. In one iteration, sparse input simulation 704 can simulate that only sparse input was received for a user whose data is within historical motion capture data 702, e.g., input made via only a few input methods, input collected for only a few body parts, etc. In this example, sparse input simulation 704 can simulate that tracking data was only received for 3 body parts and limit its usable data to simulated sparse tracking input data 706 collected at those body parts.

Process 700 can perform full body synthesis 708 on simulated sparse tracking input data 706. For example, using historical motion capture data 702 for simulated sparse tracking input data 706 captured only at the 3 body parts of the user, full body synthesis 708 can generate an estimated body scale 710 of the user (e.g., estimated height, estimated body part lengths, etc.). Full body synthesis 708 can further generate a full plausible estimated body pose 712 based on simulated sparse tracking input data 706 captured only at the 3 body parts of the user.

The machine learning model can compare the estimated body pose 712 for a particular frame (or set of frames) and/or estimated body scale 710 for the user to the known pose and/or body scale of the user stored in historical motion capture data 702 to determine the accuracy of the estimations, and to further train the machine learning model to become more accurate. For example, the machine learning model can calculate one or more training losses (as described further herein with respect to FIG. 5) indicating how well the model is estimating the training data. It is contemplated that, in some implementations, process 700 can be performed in multiple iterations, consecutively, simultaneously, and/or concurrently, for a large amount of training data in historical motion capture data 702, to further refine the machine learning mode.

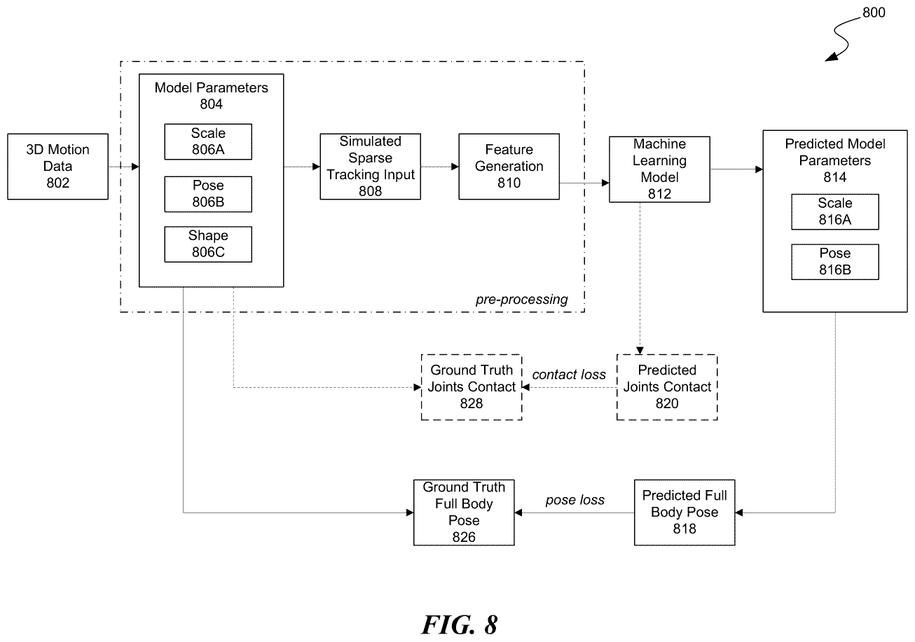

FIG. 8 is a block diagram illustrating an exemplary training pipeline 800 for a machine learning model 812 trained to estimate full body pose of a user according to some implementations of the present technology. Three-dimensional (3D) motion data 802 (and/or any data indicative of position, orientation, rotation, trajectory, etc.) corresponding to particular body parts of a user can be pre-processed to extract model parameters 804 (e.g., scale 806A, pose 806B, and shape 806C) for a model simulating the 3D motion data 802. Simulated sparse tracking input 808 can be extracted from 3D motion data 802 for a period of time (e.g., a certain number of frames) and for data corresponding to a certain number of sparsely tracked body points (e.g., 3 for head and hands; 16 for upper body; 5 for head, hands, and ankles; etc.) based on model parameters 804. Simulated sparse tracking input 808 can be provided to feature generation 810, which can extract relevant features from simulated sparse tracking input 808.

Feature generation 810 can provide the relevant features to machine learning model 812, which can be similar to any of the machine learning models described herein in some implementations. From the relevant features of simulated sparse tracking input 808 identified by feature generation 810, machine learning model 812 can determine predicted model parameters 814, including predicted scale 816A and predicted pose 816B, from which predicted full body pose 818 can be generated. Ground truth full body pose 826 can be determined from ground truth model parameters 804, and predicted full body pose 818 can be compared to ground truth full body pose 826 to calculate pose loss. The calculated pose loss can be used to update and refine machine learning model 812 in training pipeline 800.

Machine learning model 812 can optionally further output predicted joints contact 820, as indicated by the dashed lines. Predicted joints contact 820 can include a prediction of whether one or more foot joints and/or one or more hip joints are in contact with the floor (or an object on the floor, such as a rug, a seat, etc.). In some implementations, predicted joints contact 820 can be made in the form of “yes” or “no” (e.g., a flag or binary 1 or 0). In some implementations, however, predicted joints contact 820 can be in the form of a probability, e.g., a percentage likelihood. In some implementations, machine learning model 812 can predict contact of the heel of the foot, the ball of the foot, or both are in contact with the floor. In implementation in an XR environment, predicted joints contact 820 of the feet can be used to enforce more realistic locomotion and reduce “foot skating” artifacts. In some implementations, predicted joints contact 820 of the feet can be used in post-processing to attach the feet to the floor when rendered in an XR environment. In some implementations, predicted joints contact 820 of the hips can be used in post-processing to attach the hips to the floor or a seat when rendered in an XR environment. In some implementations, if the hips are predicted to be in contact with a seat, predicted joints contact 820 can further predict the feet to be on the floor. Predicted joints contact 820 can be compared to ground truth joints contact 828 to calculate contact loss. The calculated contact loss can be used to update and refine machine learning model 812 in training pipeline 800.

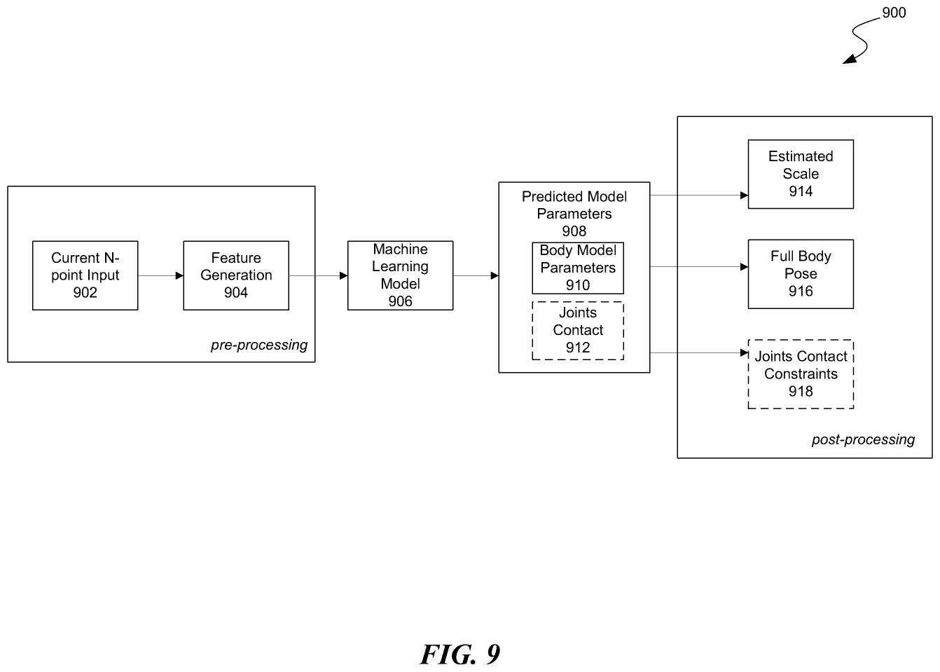

FIG. 9 is a block diagram illustrating an exemplary prediction pipeline 900 for a machine learning model 906 estimating full body pose 916 of a user based on current N-point input 902 according to some implementations of the present technology. In pre-processing, current N-point input 902 can be provided to feature generation 904. Current N-point input 902 can include any data indicative of position, orientation, rotation, motion, trajectory, etc. of N body parts of the user. In some implementations, current N-point input 902 can be sparse input, e.g., input correlating to 3 body parts (e.g., head and hands, as tracked by an XR device). In some implementations, current N-point input 902 can correlate to 5 body parts (e.g., head, hands, and ankles, as tracked by an XR device and ankle-worn IMU smart devices). Current N-point input 902 can be obtained over a period of time, e.g., having a particular number of frames at which data was captured. Feature generation 904 can receive current N-point input 902 and extract relevant features from all of the available data.

Feature generation 904 can provide the extracted relevant features to machine learning model 906. In some implementations, machine learning model 906 can be trained as described herein with respect to FIGS. 5, 7, and/or 8. Machine learning model 906 can generate predicted model parameters 908, including predicted body model parameters 910 and, optionally, predicted joints contact 912 (as indicated by the dashed lines). In post-processing, predicted model parameters 908 can be used to generate estimated scale 914 of the user (e.g., height, bone lengths, etc.) and full body pose 916, as described further herein. In some implementations, in post-processing, predicted joints contact 912 can optionally be used to generate joints contact constraints 918 (as indicated by the dashed lines). In some implementations, joints contact constraints 918 can be used to prevent feet sliding when full body pose 916 of the user is used in an XR environment.

A “machine learning model,” as used herein, refers to a construct that is trained or configured using data set(s) (e.g., training data) to make predictions or provide probabilities for new data items, whether or not the new data items were included in the data set(s). For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include: neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the machine learning model can be a neural network with multiple input nodes that receive data about body poses or movements. The input nodes can correspond to functions that receive the input and produce results. These results can be provided to one or more levels of intermediate nodes that each produce further results based on a combination of lower level node results. A weighting factor can be applied to the output of each node before the result is passed to the next layer node. At a final layer, (“the output layer,”) one or more nodes can produce a value classifying the input. In some implementations, such neural networks, known as deep neural networks, can have multiple layers of intermediate nodes with different configurations, can be a combination of models that receive different parts of the input and/or input from other parts of the deep neural network, or are convolutions or recurrent-partially using output from previous iterations of applying the model as further input to produce results for the current input.

A machine learning model can be trained with supervised learning, where the training data includes body poses or movements of a user as input and a desired output, such as a full body pose (i.e., a full body representation). Motion and/or other tracking data of the user can be provided to the model. Output from the model can be compared to the desired output for that input and, based on the comparison, the model can be modified, such as by changing weights between nodes of the neural network or parameters of the functions used at each node in the neural network (e.g., applying a loss function). After applying the input in the training data and modifying the model in this manner, the model can be trained to evaluate new data. Similar training procedures can be used for the various machine learning models discussed above.

FIG. 10 is a conceptual diagram illustrating an example 1000 kinematic model of a user for an XR system. On the left side, example 1000 illustrates points defined on a body of a user 1002 while these points are again shown on the right side of FIG. 10 without the corresponding person to illustrate the actual components of the kinematic model. These points can include eyes 1004 and 1006, nose 1008, ears 1010 (second ear point not shown), chin 1012, neck 1014, clavicles 1016 and 1020, sternum 1018, shoulders 1022 and 1024, elbows 1026 and 1028, stomach 1030, pelvis 1032, hips 1034 and 1036, hands 1037 and 1045, wrists 1038 and 1046, palms 1040 and 1048, thumb tips 1042 and 1050, finger tips 1044 and 1052, knees 1054 and 1056, ankles 1058 and 1060, and tips of feet 1062 and 1064. In various implementations, more or less points are used in the kinematic model. Some corresponding labels have been put on the points on the right side of FIG. 10, but some have been omitted to maintain clarity. Points connected by lines show that the kinematic model maintains measurements of distances and angles between certain points, such as bone and/or body part lengths as described further herein. In some implementations, because points 1004-1010 are generally fixed relative to point 1012, they do not need additional connections.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for synthesizing a full body representation of a user for application in an artificial reality environment, the method comprising:
obtaining, over multiple frames, one or more body tracking signals for one or more body parts of a body of the user in a real-world environment; and
based on the one or more body tracking signals, synthesizing the full body representation of the user by:
estimating scale of the body of the user by applying a machine learning model to the one or more body tracking signals;
normalizing at least one of: A) one or more positions of the one or more corresponding body parts, estimated from the one or more body tracking signals, to be independent of the estimated scale, B) one or more trajectories of the one or more body parts, estimated from the one or more body tracking signals, based on the estimated scale, C) a representation of space, surrounding the user in the real-world environment, based on the estimated scale, or D) any combination thereof; and
synthesizing multiple poses of the body of the user, over the respective multiple frames, using the one or more body tracking signals and the at least one of A), B), C), or D), by applying a neural network trained on: i) historical motion data, of other bodies of other users, captured by multiple input sensors, and ii) one or more masking techniques applied to the historical motion data, the one or more masking techniques accounting for lack of visibility of one or more other body parts, of the other bodies of the other users, by the multiple input sensors.

2. The method of claim 1, wherein the one or more body tracking signals are obtained from at least one sensor, the at least one sensor including an inertial measurement unit, an image capture device, an electromyography sensor, or any combination thereof.

3. The method of claim 2, wherein the at least one sensor is included in at least one of an artificial reality head-mounted display and/or a device worn by the user that is external to the artificial reality head-mounted display.

4. The method of claim 1, wherein each of the one or more body tracking signals includes a position and orientation of a corresponding body part, of the one or more body parts, at a frame of the multiple frames.

5. The method of claim 4, wherein each of the one or more body tracking signals further includes a confidence value for the position and orientation of the corresponding body part, the confidence value being generated based on visibility of the corresponding body part by one or more sensors capturing the respective body tracking signal.

6. The method of claim 1, wherein the scale of the body of the user includes at least one of height of the user and/or one or more bone lengths of the user.

7. The method of claim 1, wherein the neural network includes at least one of a temporal convolutional encoder, a long short-term memory network, a multi-task multi-layer perception model, or any combination thereof.

8. The method of claim 1, wherein synthesizing the multiple poses includes at least one of D) estimating a global position and orientation of the body of the user in the representation of space, E) estimating one or more bone lengths of the user, F) estimating one or more poses, of the multiple poses of the body of the user, based on anatomical body model, G) estimating a probability that one or more feet joints, of the body of the user, are in contact with ground in the real-world environment, H) estimating a probability that one or more hips, of the body of the user, are in contact with a physical object or the ground in the real-world environment, or I) any combination thereof.

9. The method of claim 1, wherein the neural network applies at least one of a body pose reconstruction loss, an anatomical representation loss, a feet sliding loss, a bone length loss, contact classification loss for feet, contact classification loss for hip, or any combination thereof.

10. The method of claim 1, wherein the body scale of the user is predicted without calibration to the user.

11. A computer-readable storage medium storing instructions, for synthesizing a full body representation of a user for application in an artificial reality environment, the instructions, when executed by a computing system, cause the computing system to:
obtain, over multiple frames, one or more body tracking signals for one or more body parts, of a body of the user in a real-world environment; and
synthesize the full body representation of the user by:
estimating scale of the body of the user by applying a first machine learning model to the one or more body tracking signals;
based on the estimated scale of the body of the user, normalizing the one or more body tracking signals; and
synthesizing multiple poses of the body of the user, over the respective multiple frames, using the one or more normalized body tracking signals, by applying a second machine learning model trained on historical motion data, of other bodies of other users, captured by multiple input sensors.

12. The computer-readable storage medium of claim 11, wherein the second machine learning model is further trained on one or more masking techniques applied to the historical motion data, the one or more masking techniques accounting for lack of visibility, of one or more other body parts of the other bodies of the other users, by the multiple input sensors.

13. The computer-readable storage medium of claim 11, wherein normalizing the body tracking signals includes A) one or more positions of the one or more corresponding body parts to be independent of the estimated scale, based on the estimating of the scale of the body and/or B) one or more trajectories of the one or more body parts based on the estimated scale.

14. The computer-readable storage medium of claim 11, wherein the instructions, when executed by the computing system, further cause the computing system to:
based on the estimated scale of the body, normalize a representation of space surrounding the user in the real-world environment,
wherein synthesizing the multiple poses of the body of the user is further based on the normalized representation of space surrounding the user in the real-world environment.

15. The computer-readable storage medium of claim 11, wherein each of the one or more body tracking signals includes a position and orientation of a corresponding body part, of the one or more body parts, at a frame of the multiple frames.

16. The computer-readable storage medium of claim 15, wherein each of the one or more body tracking signals further includes a confidence value for the position and orientation of the corresponding body part, the confidence value being generated based on visibility of the corresponding body part by one or more sensors capturing the respective body tracking signal.

17. A computing system for synthesizing a full body representation of a user for application in an artificial reality environment, the computing system comprising:
one or more processors; and
one or more memories storing instructions that, when executed by the one or more processors, cause the computing system to:
obtain, over multiple frames, one or more body tracking signals for one or more body parts, of a body of the user in a real-world environment; and
based on the one or more body tracking signals, synthesize the full body representation of the user by:
estimating scale of the body of the user by applying a machine learning model;
based on the estimating of the scale of the body, normalizing one or more positions of the one or more corresponding body parts, identified from the one or more body tracking signals, to be independent of the estimated scale; and
synthesizing multiple poses of the body of the user, over the respective multiple frames, using the one or more body tracking signals, by applying a neural network trained on historical motion data captured by multiple input sensors.

18. The computing system of claim 17, wherein the neural network includes at least one of a temporal convolutional encoder, a long short-term memory network, a multi-task multi-layer perception model, or any combination thereof.

19. The computing system of claim 17, wherein synthesizing the multiple poses includes at least one of D) estimating a global position and orientation of the body of the user in the representation of space, E) estimating one or more bone lengths of the user, F) estimating one or more poses, of the multiple poses of the body of the user, based on anatomical body model, G) estimating a probability that one or more feet joints, of the body of the user, are in contact with ground in the real-world environment, H) estimating a probability that one or more hips, of the body of the user, are in contact with a physical object or the ground in the real-world environment, or I) any combination thereof.

20. The computing system of claim 17, wherein the neural network applies at least one of a body pose reconstruction loss, an anatomical representation loss, a feet sliding lose, a bone length loss, contact classification loss for feet, contact classification loss for hip, or any combination thereof.
